(19) United States
(12) Patent Application Publication
(10) Pub. No.: US 2024/0199372 A1
(43) Pub. Date: Jun. 20, 2024

(54) METHOD AND DEVICE FOR NON-CONTACT CANCELING OF TRIGGERED BUTTONS

(71) Applicant: m'Al Touch Technology Co., Ltd., Taipei City (TW)

(72) Inventors: Hung-Wen CHEN, Hsinchu City (TW); Yi-Jiun SHEN, Taoyuan City (TW); Chen-Wei HU, Kaohsiung City (TW)

(73) Assignee: m'Al Touch Technology Co., Ltd., Taipei City (TW)

(21) Appl. No.: 18/125,981

(22) Filed: Mar. 24, 2023

(30) Foreign Application Priority Data
Dec. 20, 2022 (TW) 111149030

(51) Int. Cl. B66B 1/46; B66B 1/34

(52) U.S. Cl. CPC B66B 1/468; B66B 1/3461; B66B 2201/4638

(57) ABSTRACT

Disclosed are techniques for elevator control. In one aspect, a sensor senses time series data. A system module identifies a feature point of a target object in the time series data, determines whether feature point coordinates of the feature point are located in an offset space, wherein the offset space has a spatial offset to a button, and sends a control signal if the offset space does not overlap with a first sensing range and the system module determines that the feature point coordinates are located in the offset space for a duration exceeding a first threshold time, or if the offset space overlaps with the first sensing range and the system module determines that the feature point coordinates are located in the offset space for a duration exceeding a second threshold time. An elevator floor controller receives the control signal and cancels the triggering of the button.

### BACKGROUND OF THE INVENTION

### 1. Field of the Invention

Aspects of the disclosure relate to the technical field of elevator control. Specifically, the aspects of the disclosure relate to the method and device for non-contact canceling of triggered buttons.

### 2. Description of the Prior Art

The operation and contact with public equipment in daily life can cause the spread of viruses and bacteria, causing a risk of disease. Some places, such as apartments, business buildings, and even hospitals or clinics, are more likely to be at high risk because of their high pedestrian flow and the irregularity of people's access. The buttons of the elevators in these places are easy to be a breeding ground for viruses regardless of whether the users touch the buttons with their fingers or other items (e.g., keys).

In order to avoid direct contact between users and buttons, there are currently many non-contact trigger button technologies, such as using infrared induction to trigger elevator buttons. However, those non-contact trigger buttons technologies are difficult to be used to cancel the triggering of a button. Therefore, when the user needs to cancel the triggering of a button, it can only be operated in a traditional contact way (such as long press or double-click, etc.), and the purpose of effectively preventing the spread of germs cannot be achieved. In addition, infrared sensing is mostly based on installing an infrared sensor in the button, and triggering the button when an object is sensed. Therefore, when the user wants to cancel the triggering of a button and touches the button, the button will be triggered again because an object has entered the range of the infrared sensor, and hence the triggered button cannot be canceled successfully. Therefore, there is currently a need for a non-contact method for canceling the triggering of a button that can be combined with elevator equipment (whether it is a contact or non-contact button triggering system) and effectively prevent the spread of germs.

### SUMMARY OF THE INVENTION

It is an object of the present disclosure to provide a non-contact method for canceling a triggered button, which can prevent the user from touching the elevator buttons, thereby effectively preventing the spread of germs through the buttons.

It is an object of the present disclosure to provide a non-contact method for canceling a triggered button, which can be combined with existing elevator equipment (whether it is a contact or non-contact button triggering system) to achieve non-contact canceling of the triggered button.

In an embodiment, a method for non-contact canceling of a triggered button comprises: sensing time series data with a sensor; identifying a feature point of a target object in the time series data using a system module; determining whether the coordinates of the feature point are located in an offset space using a system module, wherein the offset space corresponds to a button of an operation panel, and has a spatial offset from the button; sending a control signal according to the fact that the offset space does not overlap with a first sensing range and the system module's determination that the feature point coordinates are located in the offset space for a duration exceeding a first threshold time or according to the fact that the offset space overlaps with the first sensing range and the system module's determination that the feature point coordinates are located in the offset space for a duration exceeding a second threshold time, wherein the second threshold time is greater than the first threshold time; and receiving the control signal using an elevator floor controller and canceling the triggering of the button according to the control signal.

With this configuration, the present disclosure can be combined with existing elevator equipment (regardless of whether it has a non-contact button triggering system), providing users with a non-contact way to cancel the triggering of a button without interfering with the existing contact or non-contact button triggering system.

### BRIEF DESCRIPTION OF THE APPENDED DRAWINGS

FIG. 1 is a schematic diagram of a device of a method for non-contact canceling of a triggered button according to an embodiment of the present disclosure.

FIG. 2 is a flow chart of a method for non-contact canceling of a trigger button according to an embodiment of the present disclosure.

FIG. 3 is a schematic diagram of an example of time series data according to an embodiment of the present disclosure.

FIG. 4A is a schematic diagram of an offset space according to an embodiment of the present disclosure.

FIG. 4B is a lookup table of buttons corresponding to offset spaces according to an embodiment of the present disclosure.

FIG. 5 is a schematic diagram of a method for non-contact canceling of a triggered button combined with a non-contact button triggering system according to an embodiment of the present disclosure.

FIG. 6 is a schematic diagram of a method for non-contact canceling of a triggered button combined with a non-contact button triggering system according to another embodiment of the present disclosure.

### DETAILED DESCRIPTION OF THE INVENTION

The following describes the method for non-contact canceling of a triggered button of the present disclosure through embodiments and drawings. With the present disclosure, those skilled in the art can understand the technology and effect of the present disclosure. However, the content disclosed below is not intended to limit the scope of the claimed subject matter. Without departing from the spirit of the present disclosure, those ordinarily skilled in the art can implement the present disclosure with embodiments of different structures and operating orders.

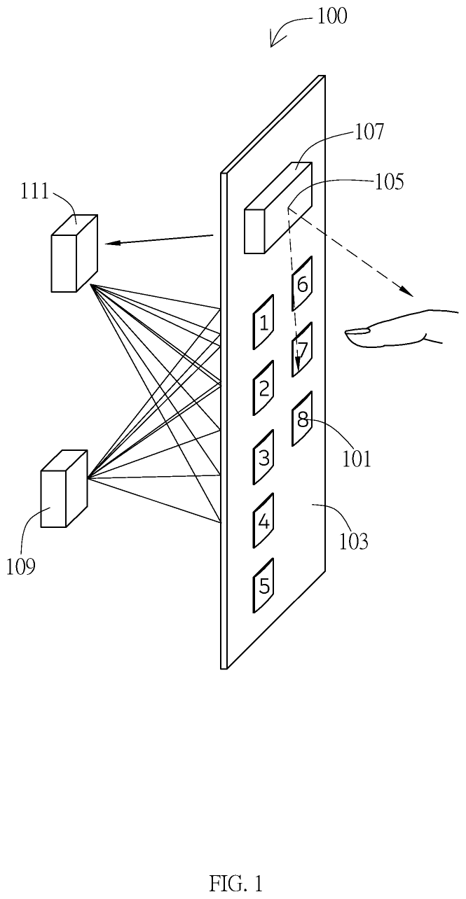

Referring to FIG. 1, an embodiment of device 100 showing the method for non-contact canceling of a triggered button of the present disclosure is illustrated. The device 100 includes a sensor 105 and a system module 107 arranged on top of the operation panel 103, wherein the sensing range of the sensor 105 covers the space in front of the button 101 of the elevator (refer to the dotted arrow in the figure). In this embodiment, the device 100 further includes a switch unit 111 coupled to the button 101 and the elevator floor controller 109, wherein the system module 107 is communicatively coupled to the switch unit 111. In this embodiment, the switch unit 111 is a relay 111. It should be noted that the sensor 105 and the system module 107 are shown as combined components in this embodiment, but the sensor 105 and the system module 107 may also be separate components in different embodiments. The present disclosure is not limited thereto. In addition, although the sensor 105 and the system module 107 are shown as being arranged on the operation panel 103 in this embodiment, they can also be arranged at other appropriate locations (such as the elevator wall) in different embodiments. The present disclosure is not limited thereto. Furthermore, although the physical button 101 is shown in this embodiment, in different embodiments, the button may not have a physical body (such as a virtual image), and the present disclosure is not limited thereto.

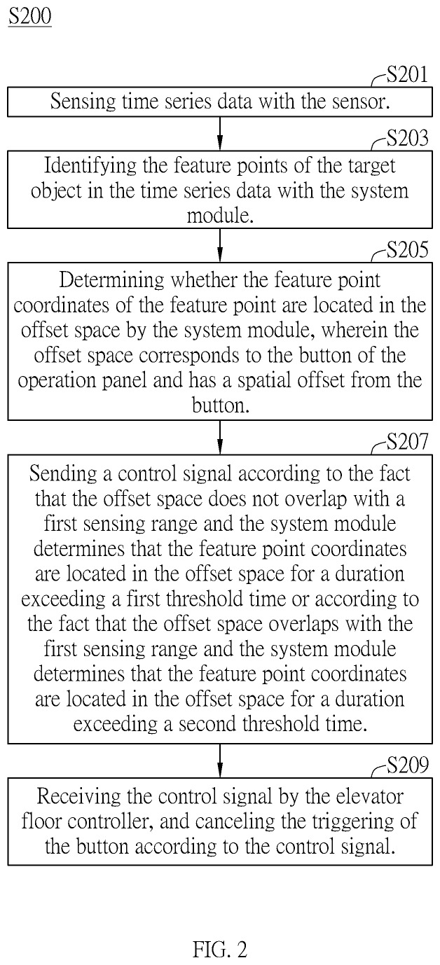

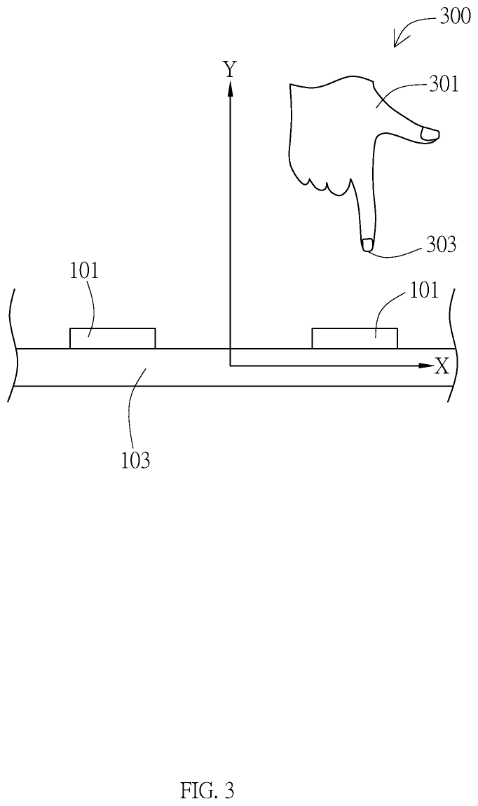

Referring to FIG. 1, FIG. 2, and FIG. 3, an embodiment of the method for non-contact canceling of a triggered button S200 of the present disclosure is illustrated. At step S201, the method includes sensing time series data 300 with the sensor 105 disposed on the operation panel 103. Referring to FIG. 3, a schematic diagram of time series data 300 is shown. Time series data 300 can be sensed by sensor 105 at a certain time interval (for example, 0.1 seconds) (FIG. 3 only shows one frame of time series data 300). At step S203, the method includes identifying the feature points 303 of the target object 301 in the time series data 300 with the system module 107. In this embodiment, the system module 107 also includes a machine learning module (not shown). By inputting the time series data 300 into the machine learning module, a preset target object 301 (i.e., a human hand) and a feature point 303 (i.e., the tip of a finger) can be identified. In this embodiment, the sensor 105 is a 3D sensor (such as a LIDAR, a time-of-flight (ToF) sensor, or a depth camera, etc.), so the sensor 105 can be used as the origin to obtain the feature point coordinates (x, y, z) of the feature point 303. It should be noted that although in this embodiment, the target object 301 is shown with a hand and the feature point 303 is shown with a fingertip, in different embodiments, the target object 301 can be an object commonly used by ordinary users to trigger the elevator button 101 such as a finger, a hand-held key, etc., and the feature point 303 can be any feature customized by the user (for example, according to the requirements of the elevator field) on the target object 301, such as fingertip, knuckle, nail center, key tip, etc. The present disclosure is not limited thereto. In addition, the machine learning module can use any appropriate image recognition technology to identify the feature points 303 of the target object 301, and in different embodiments, it can also use traditional image processing technologies other than machine learning (such as skin color recognition, contour extraction, etc.), and the present disclosure is not limited thereto.

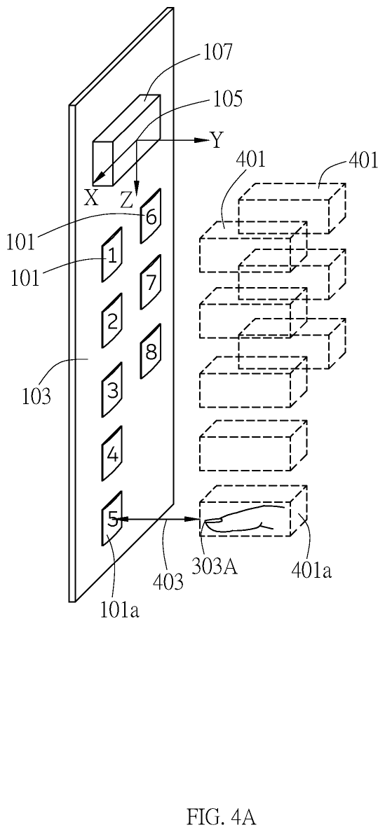

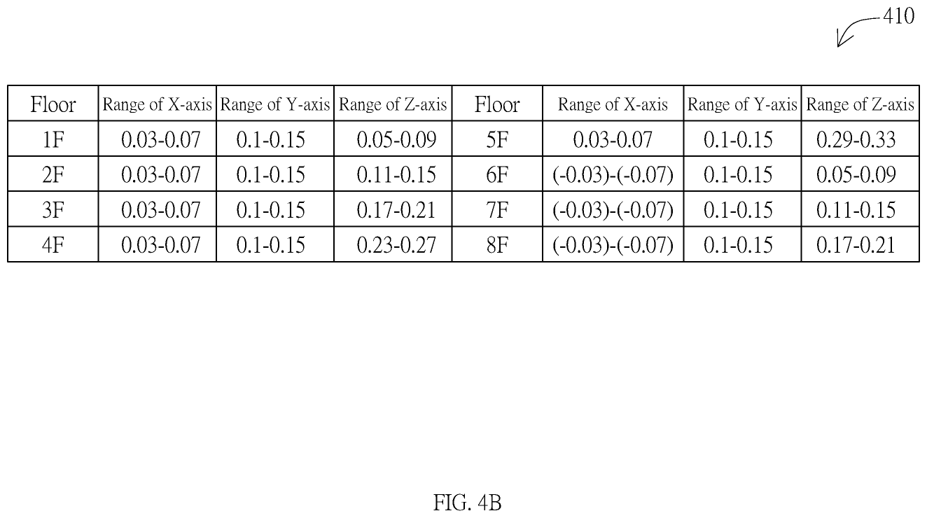

Referring to FIG. 4A and FIG. 4B, an embodiment of the method for non-contact canceling of a triggered button S200 of the present disclosure is illustrated. At step S205, the method includes determining whether the feature point coordinates of the feature point 303 are located in the offset space 401 using the system module 107, wherein the offset space 401 corresponds to the button 101 of the operation panel 103, and has a spatial offset 403 from the button 101. Referring to FIG. 4A, each offset space 401 corresponds to a button 101. For example, the offset space 401a corresponds to the button 101a indicating the fifth floor (5F). In this embodiment, the offset space 401 is a cuboid space and has a range of coordinates (x₀-x₁, y₀-y₁, z₀-z₁) in the three-dimensional space, wherein the Y coordinate value is related to the offset 403. Referring to FIG. 4B, FIG. 4B is a schematic diagram of the lookup table 410 of the coordinate range of the offset space 401 corresponding to the button 101. The system module can obtain the coordinate range of the offset space 401 corresponding to different buttons 101 through the lookup table 410. For example, the coordinate range of the offset space 401a corresponding to the 5F button 101 is (0.03-0.07, 0.1-0.15, 0.29-0.33). It should be noted that the coordinate ranges of the offset space 401 shown in FIG. 4B is only for illustrative purposes. In different embodiments, the users can set the coordinate range according to the arrangement of buttons on the operation panel 103 or in other appropriate ways, and the present disclosure is not limited thereto.

Referring to FIG. 4A and FIG. 4B, the embodiment is continued. After obtaining the feature point coordinates (x, y, z) through steps S201 and S203, the system module 107 uses the lookup table 410 to compare the feature point coordinates (x, y, z) with the coordinates (x₀-x₁, y₀-y₁, z₀-z₁) of the offset space 401 and determines whether the feature point coordinates are within the offset space 401. For example, assuming that the feature point coordinates of the feature point 303A shown in FIG. 4A are (0.045, 0.12, 0.305), the system module 107 can determine that the feature point 303A is located in the offset space 401a corresponding to 5F according to the lookup table 410 shown in FIG. 4B. It should be noted that although the offset space 401 is shown as a cuboid space in this embodiment, the offset space 401 may also be other forms of space (such as a cylinder, point, line, or plane) in different embodiments, and the present disclosure is not limited thereto.

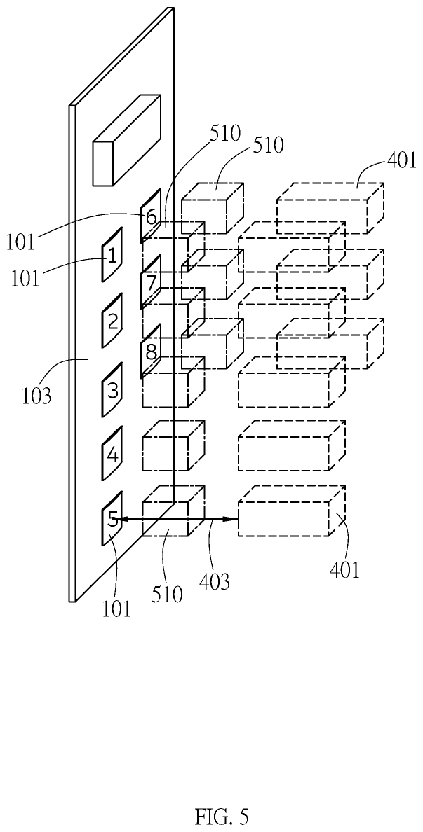

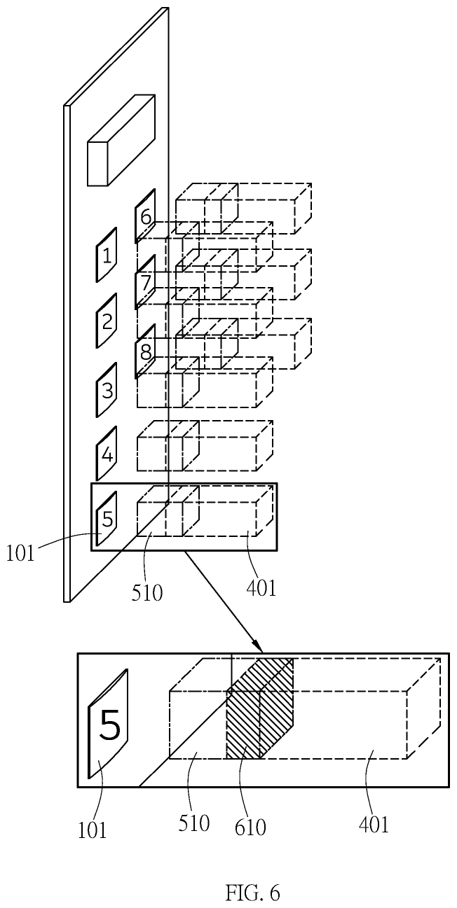

Referring to FIG. 5 and FIG. 6, the embodiment of the method for non-contact canceling of the triggered button S200 of the present disclosure is continued. At step S207, the method includes sending a control signal if the offset space 401 does not overlap with a first sensing range 510 and the system module 107 determines that the feature point coordinates are located in the offset space 401 for a duration exceeding a first threshold time or if the offset space 401 overlaps with the first sensing range 510 and the system module 107 determines that the feature point coordinates are located in the offset space 401 for a duration exceeding a second threshold time, wherein the second threshold time is greater than the first threshold time. In this embodiment, the first sensing range 510 refers to the sensing range of the sensor used in a non-contact button triggering system which is combined with the present disclosure. Use infrared sensing technology as an example of a non-contact button triggering system. The infrared sensing technology usually includes installing an infrared sensor (not shown) in each button 101, and each infrared sensor has a first sensing range 510. When an object enters the first sensing range 510 of the button 101, the non-contact button triggering system will trigger the button 101. When the method for non-contact canceling of the triggered button S200 of the present disclosure is combined with the infrared sensing technology, the offset 403 between the offset space 401 and the button 101 can be adjusted so that the offset space 401 can partially overlap or not overlap with the first sensing range 510. The two situations that the offset space 401 partially overlaps and does not overlap with the first sensing range 510 will be described below with reference to FIG. 5 and FIG. 6 respectively.

First, referring to FIG. 5, the situation that the offset space 401 does not overlap with the first sensing range 510 is illustrated. By adjusting the offset 403 between the offset space 401 and the button 101, the offset space 401 and the sensing range 510 can be staggered. In this case, when the system module 107 determines that the feature point coordinates are located in the offset space 401 for a duration exceeding the first threshold time, the system module 107 will send the control signal. Since the offset space 401 does not overlap with the sensing range 510, when the user cancels the triggered button by the method S200 of the present disclosure, the finger of the user will not enter the sensing range 510. As a result, the button will not be triggered again, and the triggered button can be effectively cancelled. In addition, since the duration should exceed the first threshold time (for example, 3 seconds or 10 frames, etc.), it can avoid a false cancelation of the triggering of the button when the user does not intend to cancel the triggering of the button (for example, when the feature point 303 of the target object 301 inadvertently and quickly passes through the offset space 401). It should be noted that the above-mentioned first threshold time may be a preset value (for example, according to the statistics of operational experience of most users), or set by the user. The present disclosure is not limited thereto.

It should be noted that although infrared sensing technology is used as an example of the non-contact button triggering system in this embodiment, the method S200 of the present disclosure can be combined with any suitable non-contact button triggering system. Similarly, the shape and distance of the first sensing range 510 shown in FIG. 5 are only intended to be exemplary, and are not intended to limit the sensor types of the non-contact button triggering system which is combined with the method of the present disclosure. In addition, in different embodiments, the method S200 of the present disclosure may also be combined with a traditional contact-type button triggering system. By adjusting the offset 403 between the offset space 401 and the button 101, the feature point 303 will not enter the offset space 401 when the target object 301 presses the button 101, thereby achieving the purpose of canceling the trigger in a non-contact manner.

Referring to FIG. 6, the situation that the offset space 401 overlaps with the first sensing range 510 is illustrated. In this embodiment, the first sensing range 510 of the non-contact button triggering system may not completely stagger with the offset space 401 but have an overlapping space 610. The method S200 may further include not sending the control signal until that the system module 107 determines that the feature point coordinates are located in the offset space 401 for a duration exceeding a second threshold time. Since the offset space 401 and the first sensing range 510 have an overlapping space 610, compared to the situation shown in FIG. 5 (that is, the non-overlapping situation), the second threshold time should be set to be greater than the first threshold time. In this way, when the feature point 303 of the target object 301 enters the overlapping space 610, as opposed to the case of non-overlapping, the system module 107 will delay sending the control signal, so as to avoid conflict with the non-contact button triggering system. In other words, by assigning a certain value to the second threshold time, it can be achieved that when the feature point 303 enters the overlapping space 610, the button 101 is preferentially triggered by the non-contact button triggering system, and then when the feature point 303 stays in the overlapping space 610 continuously, the triggered button 101 will be canceled by this method. It should be noted that the aforementioned second threshold time may be a preset value (for example, according to the statistics of operational experience of most users), or set by the user, and the present disclosure is not limited thereto.

In addition, in different embodiments, the determination of whether the duration exceeds the first threshold time or the second threshold time may further depend on the distance weight between the feature point coordinates and the operation panel 103. In this embodiment, different distance weights can be given according to the distance between the feature point coordinates and the operation panel 103 (for example, when the distance from the operation panel 103 is less than 5 centimeters, the distance weight can be doubled), so that the distance between the feature point coordinates and the operation panel 103 may affect the time to reach the first threshold time or the second threshold time (for example, reduce the time to ½). It should be noted that the aforementioned values of the distance weights are only examples, and the distance weights can be set according to requirements in different embodiments, and the present disclosure is not limited thereto.

The embodiment of the method for non-contact canceling of the triggered button S200 of the present disclosure is continued. At step S209, the method includes receiving the control signal with the elevator floor controller 109 and canceling the triggering of the button 101 according to the control signal. Referring to FIG. 1, in this embodiment, the system module 107 communicatively controls the relay 111, wherein the relay 111 is coupled to the button 101. When the system module 107 determines that the feature point coordinates are located in the offset space 401, the system module 107 will communicatively control the relay 111 to close the circuit to send a control signal to the elevator floor controller 109. For example, assuming that the system module 107 determines at step S205 that the feature point coordinates of the feature point 303A are located in the offset space 401a corresponding to 5F, the system module 107 controls the relay 111 to send out the control signal of canceling the triggering of the 5F button 101a to the elevator floor controller 109. It should be noted that elevator floor controllers 109 of different brands may be configured to receive different control signals to cancel the triggering of a button (for example, press the button twice (that is, input two pulses) or press the button for a long time (that is, input a longer pulse) to cancel the triggering of a button). The system module 107 of the present disclosure can be set according to the requirements of the control signal of elevators of different brands. In addition, although in this embodiment, the system module 107 communicatively controls the relay 111 to send out the control signal, in different embodiments, the device 100 may not include the relay 111, and may use other appropriate methods to send the control signals to the elevator floor controller 109 (for example, through the RS485 communication protocol). The present disclosure is not limited thereto.

Another embodiment of the present disclosure provides a device 100 for non-contact canceling of a button trigger, which is used to implement the method S200 in the foregoing embodiments. Referring to FIG. 1, the device 100 includes a plurality of buttons 101 arranged on the operation panel 103, and a sensor 105 arranged at a position higher than the buttons 101 on the operation panel 103, wherein the sensor is electrically connected to the system module 107 and the switch unit 111, which is coupled to the button 101 and the elevator floor controller 109. In this embodiment, the sensor 105 is a 3D sensor (such as a depth camera). Referring to FIG. 2, the sensor 105 executes step S201; the system module 107 executes steps S203-S207; and the elevator floor controller 109 executes step S209. It should be noted that although the sensor 105 is arranged on the operation panel 103 at a position higher than the buttons 101 in this embodiment, in different embodiments, the sensor can be arranged in any suitable position (such as the elevator wall), and the present disclosure is not limited thereto.

The above disclosure is only a preferred embodiment of the present disclosure and is not intended to limit the scope of the claims of the present disclosure. The sequence of the method described herein is only an exemplary illustration, and those ordinary skilled in the art can modify the sequence of the processes under the equivalent concept of the present disclosure. In addition, unless there is a clear contradiction with the context, the singular terms “a” and “the” used in this context also includes plural situation, and the terms “first” and “second” are also intended to make those ordinary skilled in the art can easily understand the concept of the content of the present disclosure, but do not intend to limit the nature of the elements in the present disclosure. The shapes, positions, and sizes of each element, component, and unit in the accompanying drawings are intended to illustrate the technical content of the present disclosure concisely and clearly, rather than limiting the present disclosure. Also, the well-known details or constructions will be omitted from the drawings.

What is claimed is:

1. A method for non-contact canceling of a triggered button, comprising:
sensing time series data with a sensor;
identifying a feature point of a target object in the time series data by a system module;
determining whether feature point coordinates of the feature point are located in an offset space by the system module, wherein the offset space corresponds to a button of an operation panel and has a spatial offset from the button;
sending a control signal according to the fact that the offset space does not overlap with a first sensing range and the system module determines that the feature point coordinates are located in the offset space for a duration exceeding a first threshold time or according to the fact that the offset space overlaps with the first sensing range and the system module determines that the feature point coordinates are located in the offset space for a duration exceeding a second threshold time, wherein the second threshold time is greater than the first threshold time; and
receiving the control signal by an elevator floor controller and canceling the triggering of the button according to the control signal.

2. The method of claim 1, wherein determining whether the feature point coordinates are located in the offset space for a duration exceeding the first threshold time or the second threshold time further includes according to a distance weight between the feature point coordinate and the operation panel.

3. The method of claim 1, wherein the offset space can be a point, a line, a plane, or a three-dimensional space.

4. The method of claim 1, wherein sending the control signal further includes communicatively controlling a switch unit through the system module to send the control signal.

5. The method of claim 1, wherein identifying the feature point of the target object includes inputting the time series data into a machine learning module of the system module for identification.

6. The method of claim 1, wherein the sensor is a 3D sensor for sensing the feature point coordinates of the feature point.

7. A device for non-contact canceling of a triggered button, comprising:
a sensor configured to sense time series data;
a system module electrically connected to the sensor and configured to:
identify a feature point of a target object in the time series data;
determine whether feature point coordinates of the feature point are located in an offset space, wherein the offset space has a spatial offset to a button of an operation panel;
send a control signal according to the fact that the offset space does not overlap with a first sensing range and the system module determines that the feature point coordinates are located in the offset space for a duration exceeding a first threshold time or according to the fact that the offset space overlaps with the first sensing range and the system module determines that the feature point coordinates are located in the offset space for a duration exceeding a second threshold time, wherein the second threshold time is greater than the first threshold time; and
an elevator floor controller used for receiving the control signal and canceling the triggering of the button according to the control signal.

8. The device of claim 7, wherein determining whether the feature point coordinates are located in the offset space for a duration exceeding the first threshold time or the second threshold time further includes according to a distance weight between the feature point coordinate and the operation panel.

9. The device of claim 7, wherein the offset space can be a point, a line, a plane, or a three-dimensional space.

10. The device of claim 7, further comprising a switch unit coupled to the button and the elevator floor controller, wherein sending the control signal further includes communicatively controlling the switch unit through the system module to send the control signal.

11. The device of claim 7, wherein identifying the feature point of the target object includes inputting the time series data into a machine learning module of the system module for identification.

12. The device of claim 7, wherein the sensor is a 3D sensor for sensing the feature point coordinates of the feature point.
